(19) United States
(12) Patent Application Publication
(10) Pub. No.: US 2026/0093309 A1
(43) Pub. Date: Apr. 2, 2026

(54) Power Management Circuit with Internal Performance States

(71) Applicant: Apple Inc., Cupertino, CA (US)

(72) Inventors: Doron Rajwan, Rishon LeZion (IL); Michael Bekerman, Los Gatos, CA (US); John H. Kelm, Belmont, CA (US); Daniel U. Becker, San Jose, CA (US)

(21) Appl. No.: 18/953,997

(22) Filed: Nov. 20, 2024

Related U.S. Application Data
(60) Provisional application No. 63/699,959, filed on Sep. 27, 2024.

(51) Int. Cl. G06F 1/324; G06F 1/28

(52) U.S. Cl. CPC G06F 1/324; G06F 1/28

(57) ABSTRACT

A computer system includes a power management circuit (PMC) that is configured to receive a set of one or more performance state requests from one or more requestors. The PMC is also configured to permit, based on the set of one or more performance state requests, a transition to an internal performance state having at least one component performance state not specified externally to the PMC as being available to the one or more requestors. The PMC is further configured to implement transitioning to the internal performance state by causing a change to operation of a particular circuit of the computer system that is not defined at the interface to the PMC. The particular circuit may be a clock signal that crosses a boundary between first and second power domains of the computer system in one implementation. The PMC may also implement performance state pinning in some implementations.

### PRIORITY CLAIM

The present application claims priority to U.S. Provisional Application No. 63/699,959, entitled “Power Management Circuit with Internal Performance States,” filed September 27, 2024, the disclosure of which is incorporated by reference herein in its entirety.

### BACKGROUND

### Technical Field

This application relates generally to computer systems, and more specifically to management of performance state transitions by a power management circuit.

### Description of the Related Art

Computer systems may operate at different performance states, depending on the workload and power consumption requirements. Managing these performance states can allow computer systems to optimize a balance between power consumption and performance. One way to manage performance states in computer systems is through Dynamic Voltage and Frequency Management (DVFM), a technique that can be controlled by a power management circuit. DVFM adjusts the voltage and frequency of the computer system dynamically based on the workload, allowing the system to operate at higher performance states when needed and scale back to lower power states when idle.

### BRIEF DESCRIPTION OF THE DRAWINGS

FIG. 1A is a block diagram of one embodiment of a computer system that includes a power management circuit (PMC) with a transition protection circuit.

FIG. 1B is a block diagram illustrating one embodiment of an interface of a PMC having internally defined performance states in addition to a set of externally defined performance states available at the PMC interface.

FIG. 1C is a block diagram of one embodiment of a computer system with multiple agent circuits in one power domain and memory interface circuits in another power domain.

FIG. 2 is a block diagram of one embodiment of a performance state processor circuit within a PMC.

FIG. 3 is a block diagram of one embodiment of a transition protection circuit within a PMC.

FIG. 4 is a flow diagram of one embodiment of a state machine within a transition protection circuit.

FIG. 5A illustrates two possible transition tables implemented within a transition protection circuit.

FIG. 5B illustrates a unified view of the two transition table circuits of FIG. 5A.

FIG. 5C illustrates both a target performance state and an internal performance state derived from the target performance state.

FIG. 6 is a flow diagram of one embodiment of a method for implementing internal performance states in a power management circuit.

FIG. 7 is a block diagram of one embodiment of a device.

FIG. 8 is a diagram illustrating example applications for systems and devices employing the disclosed techniques.

FIG. 9 is a block diagram illustrating an example computer-readable medium that stores circuit design information for implementing devices that employ the disclosed techniques.

### DETAILED DESCRIPTION

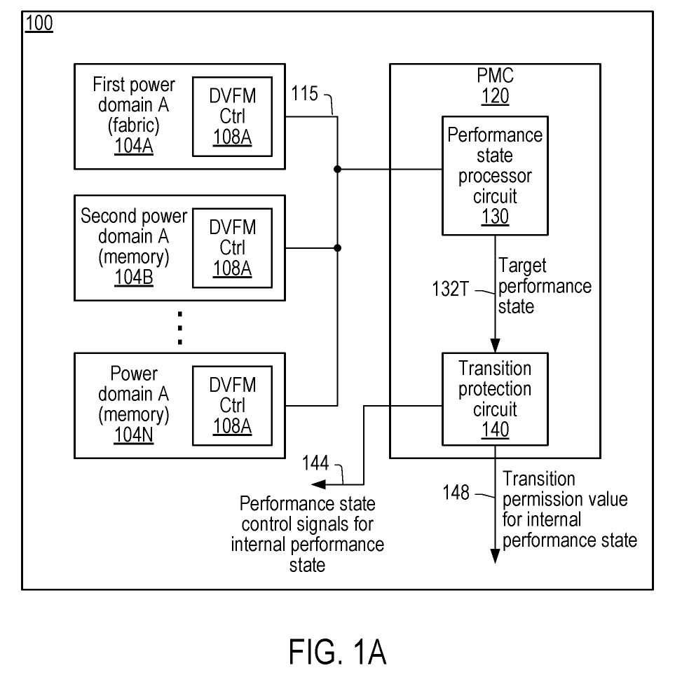

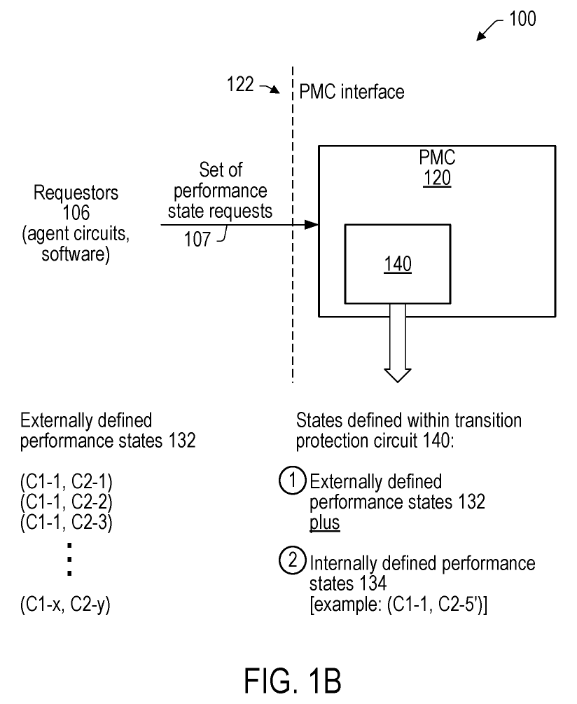

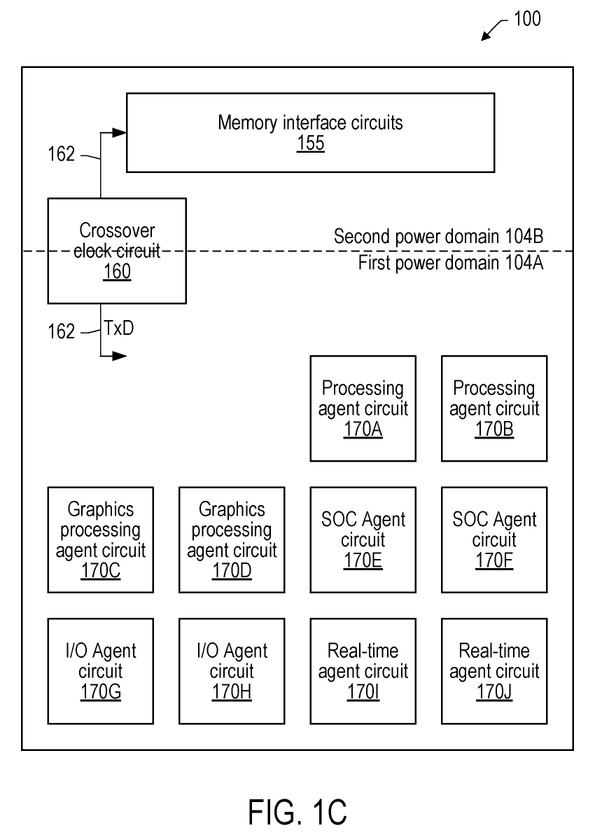

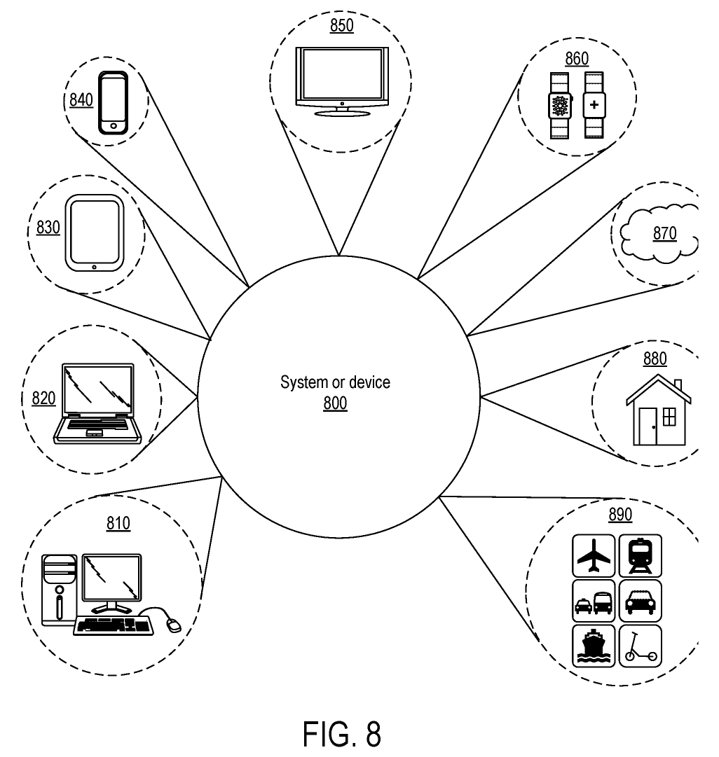

FIG. 1A is a block diagram of one embodiment of a computer system that includes a power management circuit (PMC). As depicted, computer system 100 includes multiple power domains 104, as well as PMC 120. PMC 120 includes performance state processor circuit 130 and transition protection circuit 140. Computer system 100 may be used in any number of different computing platforms, as will be described with reference to FIG. 8.

As used herein, a “power domain” is a collection of circuits that use the same power supply, and thus can be controlled separately from other power domains. Computer system 100 may have multiple power domains 104, including a first power domain 104A (or simply, power domain 104A, which may correspond to agent circuits coupled to a system fabric in one embodiment) and a second power domain 104B (or power domain 104B, which may correspond to memory interface circuits in one embodiment). Settings of a power domain can include operating voltages and frequencies; accordingly, power domains can have separate voltage rails and separately controllable clocks relative to other power domains.

Computer system 100 includes various hardware circuits situated in one of power domains 104. In the illustrated embodiment, fabric components are located in power domain 104A. Fabric components can include various agent circuits including processor circuits, as well as components that implement the memory hierarchy, including, in various implementations, caches such as the L1 cache, L2 cache, last-level cache (LLC), etc. Similarly, an interface to a memory subsystem (e.g., a DRAM control subsystem, or DCS) may be located in power domain 104B. Any number of power domains may be present in computer system 100, as exemplified by depiction of domains 104A-N.

As shown, each power domain includes at least one DVFM control circuit 108 (e.g., DVFM control circuit 108A in power domain 104A, DVFM control circuit 108B in power domain 104B, etc.). Within a given power domain, DVFM control circuits 108 located in that domain are configured to choose an appropriate DVFM setting (DVFM state or performance state) for the power domain, commonly from a predefined group of DVFM settings. In some embodiments, a given DVFM control circuit 108 utilizes a finite state machine (FSM) to control transitions from one DVFM state to another based on any suitable criterion. A given DVFM setting typically specifies an operating voltage and a clock frequency for the power domain, but DVFM control circuits 108 can also make requests based on desired bandwidth, latency, etc. in different embodiments. Generally speaking, a request made by DVFM control circuit 108 can be said to be a performance state request.

The various DVFM control circuits 108 communicate performance state requests over interface 115 to power management circuit (PMC) 120. PMC 120 is configured to manage various energy consumption aspects of computer system 100, including aspects relating to performance state requests. As noted, different power domains within computer system 100 may have different performance states (e.g., different operating voltages and frequencies). Certain system-level combinations of performance states for different power domains may be regarded as invalid (e.g., fabric components at a relatively high performance state while memory interface is at a relatively low performance state). To clarify, a system-level combination of performance states includes component performance states for multiple domains (e.g., (P1, P2), where P1 is a component performance state for power domain 104A and P2 is a component performance state for 104B). Sets of invalid combination of performance states may be specified during the design process and enforced through values hard coded in a given computer system 100. In other implementations, invalid states may be specified upon booting of computer system 100.

PMC 120 includes a performance state processor circuit 130 that is configured to receive a plurality of performance state requests from DVFM control circuits 108, each of which indicates a requested transition from a current performance state to a new performance state. Note that DVFM control circuits 108 typically issue performance state transition requests independently of one another. As noted, multiple performance state requests might be made from a given power domain 104. Accordingly, performance state processor circuit 130 is configured not only to determine what the new set of performance states should be for the various power domains 104 based on all “votes” received, but also to ensure that this system-level set of performance states is not invalid. Performance state processor circuit 130, commonly based on software or firmware, will grant or deny a given performance state transition request, depending on whether the request (possibly in combination with other ongoing or co-pending requests from one or more other DVFM control circuits 108 or other power domains 104) may cause an invalid system-level state. The output of performance state processor circuit 130 is target performance state 132T, which defines a performance state for at least two different power domains. For example, target performance state may specify a P1 component performance state for a first power domain and a P2 component performance state for a second power domain.

For security reasons, PMC 120 further includes a transition protection circuit 140, which is configured to monitor, in hardware, the DVFM-related operation of computer system 100 and avoid scenarios in which performance state processor circuit 130 permits invalid system-level combinations of performance states. Transition protection circuit 140 and performance state processor circuit 130 are aware of the same set of invalid system-level states.

Target performance state 132T that is output by performance state processor circuit 130 is a system-level set of performance states that are composed of component performance states that are defined externally to PMC 120 as being available to entities (requestors) making performance state requests. Notably, transition protection circuit 140 is also configured to permit transitioning to certain “internal” performance states that are transparent (i.e., not visible) to the requestors. To this end, transition protection circuit 140, in response to detecting certain conditions that lead to a transition to one of these internal performance states, is configured to assert a transition permission value 148 for one of these internal performance states, in addition to one or more performance state control signals 144 that is used to control some circuit within computer system that corresponds to this internal performance state.

FIG. 1B further illustrates these internal performance states within the context of one embodiment of computer system 100. As depicted PMC 120 includes a PMC interface 122 that allows requestors 106 to submit performance state requests for desired performance state transitions. The collection of performance state requests received from various DVFM control circuits 108 throughout computer system 100 is referred to as set of performance state requests 107.

Requestors 106 constitute any entities within computer system 100 that are able to make performance state requests. Requestors 106 can thus include a variety of types of agent circuits that are able to sink and source transactions within computer system 100. Types of agent circuits are discussed in more detail with respect to FIG. 1C and in the section below entitled “AGENT CIRCUITS.” Requestors 106 may also include software entities that are made by processor circuits on behalf of software processes.

Requestors 106 are able to make performance state requests in various forms—for example, for a desired amount of bandwidth or latency. Requestors 106 can also request a particular component performance state. For example, DVFM control circuit 108A can request a component performance state C1-1 for power domain 104A for the fabric, while DVFM control circuit 108B can request a component performance state C2-3 for power domain 104B for the memory interface. (Note that a DVFM control circuit 108 can also make a performance state request for multiple power domains—e.g., a particular combination of fabric and memory interface performance states.)

If a requestor 106 makes a performance state request that includes a desired performance state, however, those components will be included within a set of performance states 132 that is defined externally to the PMC. In many cases, set of performance states 132 may be defined as part of an API for PMC interface 122. This approach is highly desirable in a design setting in which multiple design teams are responsible for designing different circuits within computer system 100.

From a design scalability perspective, however, the present inventors have recognized that the externally defined set of performance states 132 can be unduly limiting. Consider a scenario in which components of computer system 100 are utilized in multiple different computing platforms, as will be described with respect to FIG. 8. In some cases, it may be desired to add support for a system-level performance state for use in one particular type of computing platform. The added performance state may not make sense, however, for other ones of the computing platforms. For example, it may be desired to add a performance state for a mobile computing platform that is particularly suited to recording video, but the added performance state is not as relevant within, say, a desktop computing platform.

Significant design effort may be needed to redesign DVFM control circuits 108 for all requestors 106 within computer system 100 to accommodate this added performance state. This may not be feasible or desirable in many or all design scenarios. To address this issue, the present inventors propose to define and permit a set of internal performance states that supplement the set of performance states 132 that are defined externally to PMC 120. In some embodiments, the internal performance states are handled/managed by transition protection circuit 140. Accordingly, PMC 120 may be configured to handle a total set of performance states, which is composed of 1) performance states 132 that are externally defined and 2) internal performance states 134 that are internally defined within PMC 120.

To briefly illustrate the use of this paradigm, consider externally defined performance states 132 shown in FIG. 1B. This set includes (C1-1, C2-3), which defines component performance state C1-1 for power domain 104A and component performance state C2-3 for power domain 104B. As will be described, requestors 106 may make a set of performance state requests 107 that leads to performance state processor circuit 130 selecting (C1-1, C2-3) as target performance state 132T. Transition protection circuit 140, however, may determine to transition to a modified target performance state (C1-1, C2-3’), where C2-3 and C2-3’ differ in some operating characteristic. State (C1-1, C2-3’) is thus an internal performance state that is not specifiable/requestable by requestors 106.

The definition and management of internal performance states within PMC 120 has multiple design advantages. First, this paradigm allows design changes needed to effectuate a new performance state to be largely centralized within PMC 120. That is, rather than having to redesign many or all DVFM control circuits 108 within computer system 100 to accommodate the new performance state, the existing definition of performance states can be retained and the design changes largely contained to PMC 120 wherein the internal performance states are managed. This allows greater ease in moving from one generation of design to another. This is particularly true when, as described above, a new performance state is not universally applicable within a spectrum of different types of computing platforms.

Furthermore, in some embodiments, detection of conditions leading to use of an internal performance state may be handled via firmware within transition protection circuit 140. This allows greater design flexibility, both in moving from one generation of design to another, as well as changing the behavior of a given design generation. Use of firmware within transition protection circuit 140 thus allows internal performance states to be added, deleted, or modified without having to redesign hardware in many instances.

Management of an internal performance state may involve control of a particular circuit within computer system 100. An example of such a particular circuit is illustrated in FIG. 1C, which depicts a crossover clock circuit 160 that is situated at the boundary of first power domain 104A (fabric with agent circuits 170) and second power domain 104B (memory interface circuits 155). In the depicted embodiment, circuits in power domains 104A and 104B operate at different clock frequencies. The transfer of data from power domain 104A to power domain 140B is performed according to transmit signal 162, which is an output of crossover clock circuit 160.

In some implementations, transmit signal 162 may run at a normal operating frequency, but this normal operating frequency can be varied in conjunction with entering an internal performance state managed by PMC 120. It may be desirable for an internal performance state to have the same performance state characteristics for power domains 104A-B relative to one of externally defined performance states 132, with the exception of a difference in the frequency of transmit signal 162. Decreasing the frequency of transmit signal 162 may allow a reduction in write bandwidth to the memory interface relative to one of the externally defined performance states 132.

FIG. 1C also illustrates the variety of different agent circuits 170 that are located within the fabric portion of computer system 100. As depicted, first power domain 104A includes processing agent circuits 170A-B, graphics processing agent circuits 170C-D, system-on-a-chip (SoC) agent circuits 170E-F, I/O agent circuits 170G-H, and real-time agent circuits 170I-J. These agent circuits are discussed at length below in the section entitled “Agent Circuits.” Real-time agent circuits 170I-J, in particular, are those agent circuits that are responsible for input/output to a user of computer system 100 that must be handled in real time. Examples of real-time agent circuits 170I-J include a display circuit, a camera circuit, and an audio circuit. These circuits are considered to operate in “real-time” because if their latency needs are not met in certain expected ways, artifacts will be evident to a user of computer system 100. Real-time circuits, as used herein, refers to circuits that perform computer I/O operations discernible to a user within a specific time interval (e.g., on the order of milliseconds). If a real-time circuit fails to carry out its functionality within a designated time window, the user experience is compromised—for example, by a loss of sound, a visible artifact or loss of data on the display, etc.

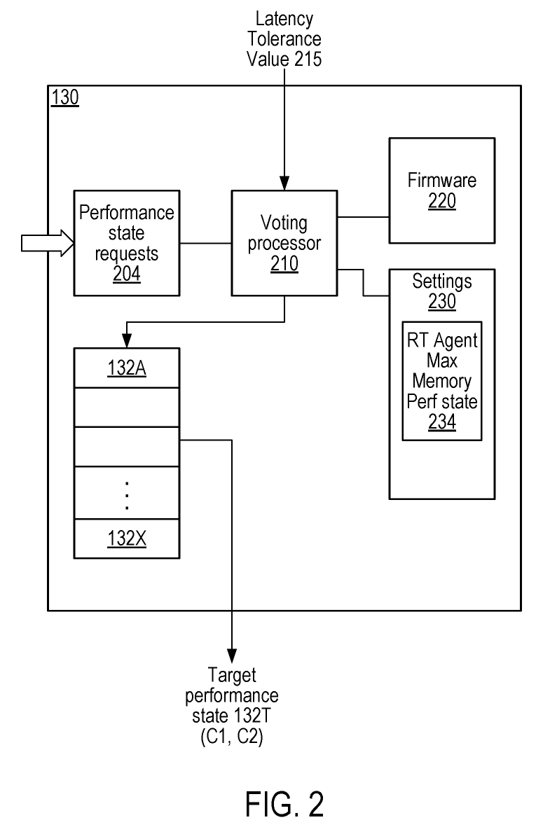

As described next with respect to FIG. 2, PMC 120 can choose to process performance state requests from real-time agent circuits 170I-J in a manner that facilitates the goal of real-time processing.

### PMC Structure

FIG. 2 is a block diagram of one embodiment of performance state processor circuit 130 within PMC 120. As depicted, performance state processor circuit 130 includes performance state requests interface circuit 204, voting processor circuit 210, firmware 220, and settings storage 230. As will be described, voting processor is configured, based on set of performance state requests 107 received at performance state requests interface circuit 204 and using firmware 220, to select one of externally defined performance states 132 as target performance state 132T.

As has been described, set of performance state requests 107 includes requests from various components within power domains 104 (e.g., camera, display circuit, CPUs, and the GPUs), including those that operate independently of one another. A given request specifies how much performance a given component currently needs. In many cases, performance state processor circuit 130 takes in all these requests and selects a system-level performance state that is typically an aggregate of the received requests such that the performance state will be high enough to support all workloads in the distributed computing setting of computer system 100.

In some embodiments, performance requests within set of performance state requests 107 can be made in various forms, including bandwidth-based requests, latency-based requests, and quality-of-service-based requests (in addition to requests specifying one or more of externally defined performance states 132). These various requests may be written to dedicated memory for such requests, which may be distributed through computer system 100 in some implementations. Performance state requests interface circuit 204 is configured to retrieve a current version of set of performance state requests 107 and make them available to voting processor circuit 210. Voting processor circuit 210, under control of instructions stored in firmware 220, is configured to translate all the various performance state request formats into a common currency: one of the system-level externally defined set of performance states 132, which is designated as target performance state 132T. (Note that the use of firmware 220 may advantageously allow the methodology for selecting a target performance state to change over time without a hardware redesign.) Target performance state 132T is sent to transition protection circuit 140, which is configured to ensure, in hardware, that the proposed transition to target performance state 132T is permitted.

### Performance State Pinning

In some embodiments, performance state processor circuit 130 is configured to set, or pin, a particular performance state (in particular, a memory performance state) regardless of what performance states are actually voted on in the requests from agent circuits 170. This functionality is orthogonal to functionality related to management of internal performance states described herein. Accordingly, the pinning functionality described next can exist in power management circuits that include internal performance state functionality as described herein, as well as those power management circuits that do not employ such functionality.

Before explaining the nature of performance state pinning, it will first be instructive to describe the nature of certain agent circuits 170 within computer system 100 that have real-time resource requests, since performance state pinning may be directed to performance state requests from these types of agent circuits. Real-time circuits with computer system 100 such as real-time agent circuits 170I-J are built around the concept of time windows for output. Consider a display circuit, which is responsible for providing output to a display for each of multiple frames per second (e.g., 30 or 60 frames per second). Accordingly, for the display circuit to operate properly, sufficient bandwidth must be provided in order to transfer all of the image data that is being displayed in a given frame from memory to the display. Real-time circuits are considered to be isochronous, in that they have to receive a certain amount of bandwidth within a fixed period of time. (Isochronous communication refers to a scenario in which the sender and the receiver are synchronized in such a way that they send/receive during the same time slots, implying the existence of a time schedule that needs to be consistent.)

A canonical example of a real-time circuit is an audio processing circuit that has low bandwidth requirements and requires a regular schedule. If audio data is not supplied to an audio processing circuit at appropriate times, there will be a timing violation, which could mean, for example, that sound of computer system 100 will drop out for a period of time. This leads to a poor user experience, and for this reason, computer system 100 may be designed to prioritize the supplying of data to real-time agent circuits. Display circuits are another example of a real-time agent circuit, since data must always be present at a display device in order to minimize or prevent visible display artifacts. A camera circuit is yet another example of a real-time agent circuit.

In many cases, the bandwidth needs of real-time agent circuits are modest and would be met with a relatively low-level performance state for memory. An increase in memory performance state leads to greater available bandwidth for real-time agent circuits, however. There are various mechanisms (e.g., latency tolerance) that allow real-time agent circuits to indicate how much data they have. But in cases in which a memory frequency switch occurs, this leads to a certain period of time in which there is no memory bandwidth available because calibration is occurring, and no new memory requests can be sent. Some real-time agent circuits, particularly those that are native to a particular computer system (e.g., incorporated onto a system-on-a-chip (SoC) or chiplet architecture), may be designed in such a way—for example, with robust buffering and prefetching—that tends to minimize the potential negative effects relating to DRAM unavailability. But other real-time agent circuits are more susceptible to such unavailability because of the way that they are architected.

For example, certain peripheral devices coupled to computer system 100, such as those connected to a bus, may communicate an amount of latency tolerance to PMC 120. Previous versions of PMC 120 may be configured to use received latency tolerance values to index into a table (not pictured) that specifies various mitigations to improve performance, including disabling clock and power gating, etc. In an extreme case, previous versions of PMC 120 may set, or pin, the memory performance state to the highest possible state for that system. Pinning the memory performance to the highest possible state has the effect of guaranteeing that there will be no memory frequency changes, since the memory performance state is already at its maximum possible value. Note that act of pinning means that the memory performance state will remain in place until the DRAM unavailability for the latency-sensitive device has passed.

Another class of devices that can have a similar lack of tolerance to DRAM unavailability perform memory transactions by fetching data into a buffer inside the controller. As long as a next portion of a memory transfer is small enough to fit inside this buffer, the associated timing is usually not problematic because data can be prefetched into the buffer long before it needs to be written out. But in scenarios in which the controller needs to transfer more data than fits into the buffer, this means that the controller can become much less tolerant to DRAM unavailability caused by memory frequency changes. Historically, this problem has also been dealt with by forcing the memory performance state to the highest possible state for some period of time. This action ensures that there will be no more frequency changes, which typically is the greatest contributor to memory unavailability.

The behavior of PMC 120 pinning a memory performance state to a maximum possible value to accommodate the latency intolerance of certain real-time agent circuits can become problematic over various generations of products. Consider two generations of computer system 100, the first generation having a first number of memory performance states for real-time agent circuits (including a maximum state Fₘₐₓ₁), and the second generation having a second, greater number of memory performance states (including a maximum state Fₘₐₓ₂ that has higher performance than Fₘₐₓ₁). A PMC in the first-generation product may pin the memory to the Fₘₐₓ₁ performance state in response to a determination that the latency tolerance of a real-time agent not being sufficient to accommodate frequency changes and the associated DRAM unavailability. The same action may occur in the second-generation product, only this time with the PMC pinning the memory to the higher Fₘₐₓ₂ performance state.

Note that, in many cases, the bandwidth needs of real-time agent circuits are modest, with the result that the Fₘₐₓ₁ performance state for memory is sufficient (or more than sufficient) to meet the agent circuit’s bandwidth requirements. Thus, in the second-generation product, the PMC may pin the memory performance state to Fₘₐₓ₂ not because it actually needs the extra bandwidth, but because it prevents further frequency changes and thus helps ensure DRAM availability.

The present inventors have recognized that pinning the memory performance state to the highest possible state for a given system in response to real-time agent circuit latency intolerance may lead to unnecessary power dissipation. To address this scenario, PMC 120 may be configured, in response to certain latency intolerance scenarios, to pin the memory performance state to a performance state that is less than the highest possible performance state. For example, it may be determined that, although the highest performance state for the memory is F9, the F7 performance state is sufficient to meet real-time agent circuits’ worst-case bandwidth requirements.

Thus, as illustrated in FIG. 2, voting processor 210 may receive a latency tolerance value 215 that indicates that some real-time agent circuit has sufficiently low tolerance for DRAM unavailability that further performance state changes should not occur for some period of time. In such a case, voting processor 210 is configured, regardless of what target performance state 132T would otherwise be dictated by performance state requests 204, to pin the memory performance state to the value of real-time agent maximum memory performance state 234, which is stored in settings 230.

Consider a scenario in which the maximum memory performance state for computer system 100 is F9, but real-time agent maximum memory performance state 234 is set to F7. Accordingly, even if voting processor 210 would otherwise set the memory performance state to F6 without taking latency tolerance value 215 into account, when real-time agent maximum memory performance state 234 is determined to be applicable, the memory performance state will be set to F7 until latency tolerance value 215 no longer indicates the presence of the DRAM unavailability scenario. Thus, if a subsequent round of voting indicates that the performance state of memory should increase to F8, the performance state will nevertheless remain at the state specified by real-time agent maximum memory performance state 234 until the DRAM unavailability scenario resolves.

Conversely, consider a scenario in which performance state requests 204 would dictate a memory performance state of F8 but latency tolerance value 215 again points to a scenario in which frequency changes are to be avoided. Real-time agent maximum memory performance state 234 would again cause the memory performance state to be pinned to F7. In this scenario, PMC 120 has effectively removed some of the memory performance states as potential transition options for as long as the latency intolerance situation persists.

In both cases described above, pinning guarantees that memory frequency changes will not occur, even though the highest possible performance state is no longer used for this purpose. Note that the term “pinning” means that the performance state will not change until some condition external to the voting requests changes (here, latency intolerance resolves). Pinning can result in both a lower memory performance state than would otherwise occur (e.g., F7 versus votes that would cause F8), and a higher memory performance state than would otherwise occur (e.g., F7 even though the votes would only necessitate F6).

Note that while pinning has been described with respect to real-time agent circuits, the concept may also be extended to other classes of agent circuits as needed.

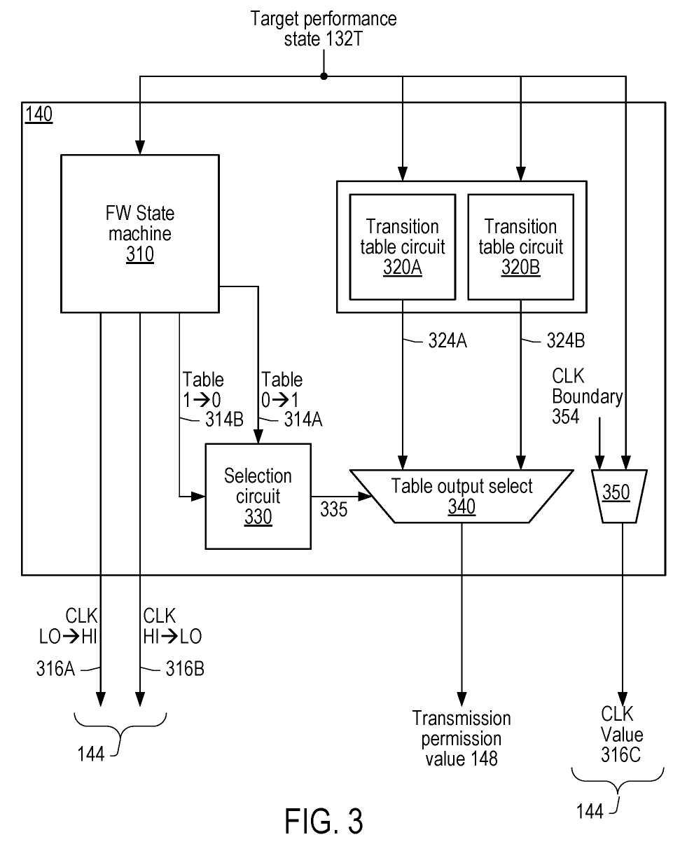

FIG. 3 is a block diagram of one embodiment of transition protection circuit 140. As depicted, transition protection circuit 140 includes firmware state machine 310, transition table circuits 320, selection circuit 330, permission output circuit 340, and clock transition circuit 350. Transition protection circuit 140 is configured to receive target performance state 132T from performance state processor circuit 130 and output performance state control signals 144 and transition permission value 148.

As will be described below, transition protection circuit 140 is configured, in response to certain inputs, to map target performance state 132T to an internal performance state not defined externally to PMC interface 122. Whether or not this mapping to an internal performance state occurs, transition protection circuit 140 is also configured to determine whether a transition to a new performance state is permitted. Stated another way, transition protection circuit 140 is configured to determine if a transition to a new performance state is permitted, whether that new performance state is target performance state 132T or internal performance state 134T derived from target performance states 132T.

Accordingly, if transition protection circuit 140 does not map target performance state 132T to an internal performance state, transition protection circuit 140 is configured to determine whether the transition to target performance state 132T is permitted. Conversely, if transition protection circuit 140 does map target performance state 132T to an internal performance state, transition protection circuit 140 is configured to determine whether the transition to the internal performance state is permitted. (Note that in some embodiments, transition protection circuit 140 will not map target performance state 132T to an internal performance state in the first instance if the transition is not permitted.) The determination of transition permissions by transition protection circuit 140 can in some implementations be performed by a circuit implementing a table that indicates permitted and non-permitted combinations of states, or by the structural equivalent of such a table. At a high level, the table indicates, for a given performance state transition (e.g., a transition to power domain 104A at performance state P1 and power domain 104B at performance state P2). One such description of a table, which may be referred to as a transition table, is found in U.S. Patent No. 11/836,026, entitled “System-on-Chip with DVFM Protection Circuit,” which is hereby incorporated by reference in its entirety.

As noted, transition protection circuit, may map target performance state 132T to an internal performance state under certain circumstances. This functionality is accomplished in the depicted embodiment through the use of multiple transition tables, labeled as transition table circuits 320A-B in FIG. 3. The use of multiple transition table circuits 320 allows the permissibility of a transition to a new performance state to vary based on the current state of firmware state machine 310.

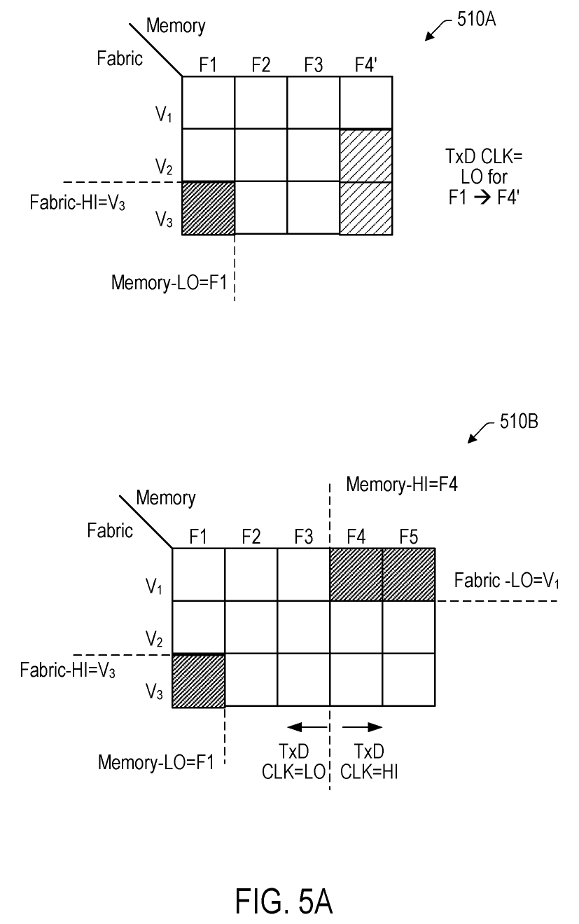

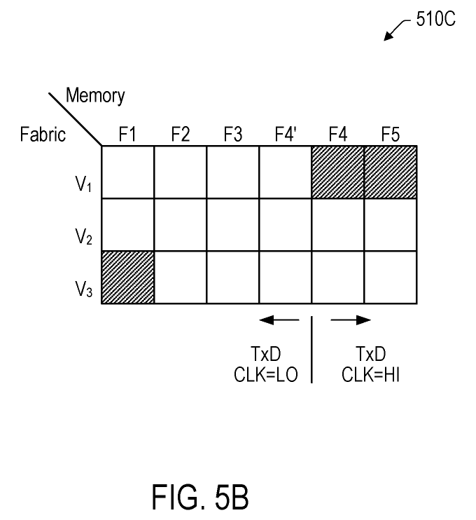

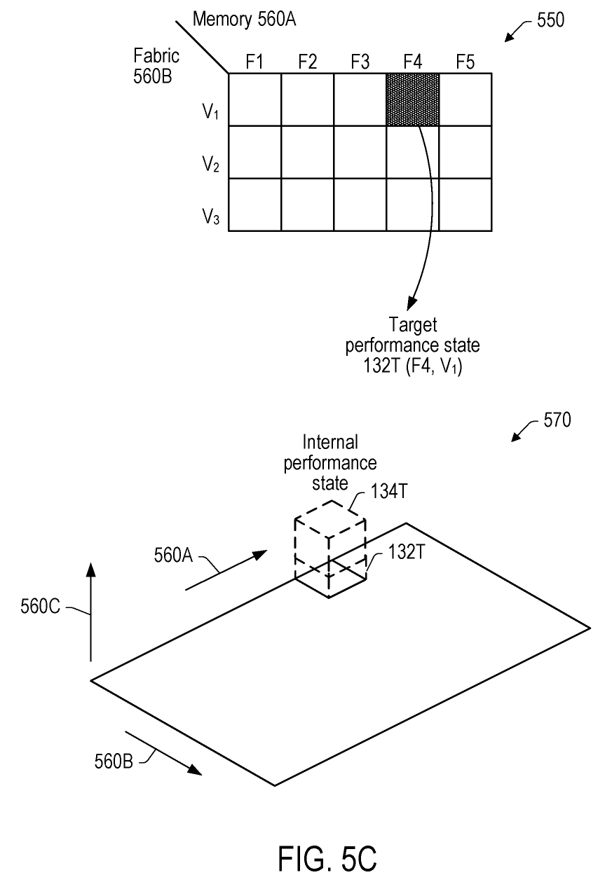

As can be seen in FIG. 3, target performance state 132T selected by performance state processor circuit 130 is conveyed to firmware state machine 310, transition table circuits 320A and B, and clock transition circuit 350. Transition table circuits 320 output transition information 324A and B, respectively, which can differ based on the fact that the contents of transition table circuits 320 can differ. In other words, a transition to target performance state 132T might be permitted by transition table circuit 320A, but not by transition table circuit 320B, and vice versa. As will be described with respect to FIGS. 5A-B, in some cases, one transition table circuit might include a permission value for an internal performance state while the other does not.

Transition information 324A-B is conveyed to permission output circuit 340, which is configured to output transition permission value 148 based on which of transition table circuits 320 is currently active, as determined by table select signal 335. Table select signal 335 is based on the current value of selection circuit 330, which is in turn controlled by table change signals 314A-B. Table select signal 335 can be said to define a current transition mode for transition protection circuit 140.

In one embodiment, selection circuit 330 is initialized to some value (e.g., 0, which causes outputs from table 320A to be selected at permission output circuit 340). Assertion of table change signal 314A causes selection circuit 330 to change to a 1, which will cause outputs from table 320B to be selected at circuit permission output 340. This state will continue until assertion of table change signal 314B causes selection circuit 330 to change back to a 0, which will cause outputs from table 320A to be selected at permission output circuit 340. (Note that in other embodiments, the logic states and references to “assertion” of signals can have reversed polarities while achieving the same results.)

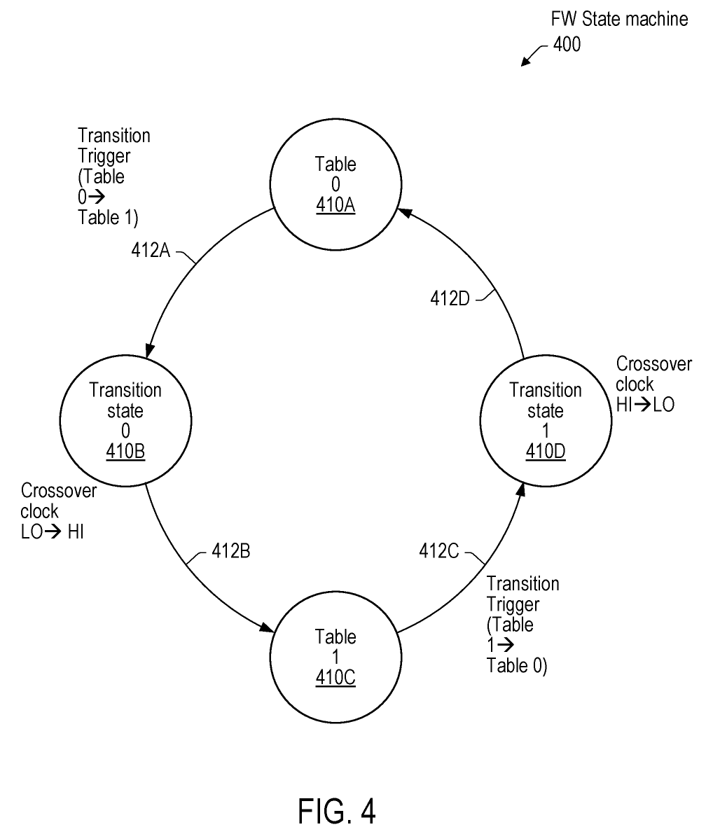

As depicted, table change signals 314A-B are asserted by firmware state machine 310, described further below with respect to FIG. 4. Firmware state machine 310, in the depicted embodiment, is also configured to control the state of a particular circuit within computer system to effectuate the transition to an internal performance state. In one embodiment, an internal performance state may include changing the state of transmit signal 162 that crosses between first power domain 104A and second power domain 104B. Accordingly, firmware state machine 310 may cause assertion of clock transition signals 316A-B. Clock transition signal 316A causes transmit signal 162 to transition from a relatively low frequency (LO) to a relatively high frequency (HI), while clock transition signal 316B causes the reverse effect. Clock transition signals 316A-B may be conveyed to circuitry (not pictured) that controls the frequency of transmit signal 162.

As just noted, in the particular implementation shown in FIG. 3, a change in the use of transition table circuits 320 can be used to cause a corresponding change in the frequency of transmit signal 162 via clock transition signals 316A-B. But changes in the frequency of transmit signal 162 may occur in other circumstances that need to be accounted for. In one implementation, the frequency of transmit signal 162 is always at LO frequency when transition table circuit 320A is in use, but may be either HI or LO when transition table circuit 320A is in use. Such an implementation is described in much more detail with respect to FIGS. 5A-B.

Clock transition circuit 350 is configured to help account for a potential change in the desired frequency of transmit signal 162 while transition table circuit 320B is in use. Clock transition circuit 350 is configured to compare one or more components of target performance states to clock boundary value 354. In one implementation, clock boundary value is equal to 5 (for F5) for a performance state for memory interface power domain 104B. If clock transition circuit 350 determines that the performance state component for the memory interface is less than performance state 5 (e.g., F4), clock value signal 316C indicates that the current frequency of transmit signal should be LO. On the other hand, if clock transition circuit 350 determines that the performance state component for the memory interface is not less than performance state 5 (i.e., is greater than or equal to 5), clock value signal 316C indicates that the current frequency of transmit signal should be HI. Clock value signal 316C can be conveyed to clock generation circuitry for transmit signal 162 to make sure this signal is at the appropriate frequency. Note that clock value signal 316C need not always cause a change. If transmit signal 162 is already at LO frequency, a transition from memory interface performance state such as from F4 to F3 will not change the frequency of transmit signal 162 in the described scenario. Conversely, if transmit signal 162 is already at HI frequency, a transition from a memory interface performance state such as F5 to F6 also will not change the frequency of transmit signal 162. But a transition from memory interface performance state F3 to F5 (or vice versa) will necessitate a change in the frequency of transmit signal 162. In one embodiment, clock generation circuitry for transmit signal 162 can compare the current frequency of transmit signal 162 to the clock value signal 316C, which is deasserted when transmit signal 162 should be at LO frequency, and asserted when transmit signal should be at HI frequency. If the current frequency of transmit signal 162 differs from what is indicated by clock value signal 316C, clock generation circuitry for transmit signal 162 can cause a change in frequency.

Note that clock transition circuit 350 or its equivalent need not be located in transition protection circuit 140. This circuit is included here to provide one implementation of how control of transmit signal 162 may be accomplished for the specific transition table circuits 320 that will be described with respect to FIGS. 5A-B.

Details of one embodiment of firmware state machine 310 are now provided with respect to FIG. 4. As depicted, state machine diagram 400 has four states: 410A-D. Two of these states are stable states (410A and 410C), while the other two are transient states (410B and 410D).

The initial state of firmware state machine 310 may be either state 410A or 410C in various embodiments. The initial value of selection circuit 330 may be set according to whether state 410A or 410C is active. As noted, table select signal 335 (which is the internal value of selection circuit 330) can be deasserted in one implementation to cause transition table circuit 320A (table 0) to be used for permission checking. Conversely, table select signal 335 can be asserted to cause transition table circuit 320B (table 1) to be used for permission checking. Table 0 may also be referred to as a “low gear” for computer system 100 (lower performance), while table 1 may also be referred to as “high gear.” For purposes of further description of FIG. 4, assume that state 410A is the initial state of firmware state machine 310.

States in tables 0 and 1 may not only have different performance states but also may be associated with different values of the crossover clock between power domains 104A and B (e.g., transmit signal 162), in keeping with the general principle that an internal performance state may involve control of some particular circuit within computer system 100. In the particular implementation described next with respect to FIGS. 5A-B, all performance states in table 0 are associated with the crossover clock having a LO frequency value, while table 1 has some performance states associated with the crossover clock having a LO frequency and some performance states associated with the crossover clock having a HI frequency.

Firmware state machine 310 transitions to transient state 410B in response to receiving transition trigger 412A. As will be described with respect to FIG. 5A, transition trigger 412A may correspond to a request to transition to a particular performance state that requires a relatively higher performance state than those found in table 0 in one embodiment. In one implementation, the particular performance state is associated with the crossover clock having the HI frequency.

In some cases, it may not be possible or advisable to transition directly to state 410C from state 410A. Accordingly, firmware state machine 310 transitions temporarily to transient state 410B. Firmware state machine 310 can pause at state 410B until it can be assured (based on receipt of transition trigger 412B) that the desired transition has been completed (for example, necessary clock signals and voltages being ready) before moving to state 410C. Furthermore, as part of the 410A410B410C transition, a signal (e.g., clock transition signal 316A) can be sent to crossover clock generation circuitry that causes transmit signal 162 to be changed to the HI frequency. Additionally, the transition to state 410C will cause the assertion of table change signal 314A in one embodiment, which causes selection circuit 330 to store a value indicative of table 1, which in turn causes table 1 to be used for evaluating the permissibility of performance state change until the assertion of transition trigger 412C.

When in state 410C, firmware state machine 310 transitions to transient state 410D in response to receiving transition trigger 412C. As will be described with respect to FIG. 5A, transition trigger 412C may correspond to a request to transition to a particular performance state that requires a relatively lower performance state than those found in table 1. In one implementation, the particular performance state is associated with the crossover clock having the LO frequency.

In some cases, it may not be possible or advisable to transition directly to state 410A from state 410C. Accordingly, firmware state machine 310 passes temporarily to transient state 410D in one embodiment. Firmware state machine 310 can pause at state 410D until it can be assured (based on receipt of transition trigger 412D) that the desired transition has been completed before moving to state 410A. Furthermore, as part of the 410C»410D»410A transition, a signal (e.g., clock transition signal 316B) can be sent to crossover clock generation circuitry that causes transmit signal 162 to be changed to the LO frequency. Additionally, the transition to state 410A will cause the assertion of table change signal 314B in one embodiment, which causes selection circuit 330 to store a value indicative of table 0, which in turn causes table 0 to be used for evaluating the permissibility of performance state change until the next assertion of transition trigger 412A.

Firmware state machine 310 can be utilized with a pair of transition tables described next with respect to FIGS. 5A-B. The particular arrangement of firmware state machine 310, along with the particular transition triggers 412, will vary based on the desired transition tables, including entries corresponding to desired internal performance states. Advantageously, the implementation of firmware state machine 310 allows updating of conditions for shifting between the different transition table circuits 320 without a hardware redesign. In other embodiments, firmware state machine 310 could of course be implemented in hardware.

FIG. 5A illustrates one possible embodiment of transition tables for transition table circuits 320A-B. In the depicted embodiment, transition table 510A is for transition table circuit 320A (also referred to as table 0 or low gear). Transition table 510B, on the other hand, is for transition table circuit 320B (also referred to as table 1 or high gear).

Both transition tables show a matrix of performance states, with the memory interface performance states (e.g., for power domain 104B) shown horizontally and the fabric performance states (e.g., for power domain 104A) shown vertically. The memory interface, in the depicted embodiment, has performance states that are tied to the speed of the memory interface and the memory (e.g., DRAM) itself. Speeds of the memory interface increase from left to right in transition tables 510. As will be described, states F1-F5 are memory interface performance states 132 that are externally defined at PMC interface 122, meaning that they are known and available to be requested by requestors 106. Performance states of the fabric (which includes agent circuits 170 within power domain 104A) in transition tables 510 are measured based on voltage levels that increase from V₁ to V₃. The three voltage levels V₁, V₂, and V₃, are also fabric performance states 132 that are defined externally at PMC interface 122. Note that the particular performance states disclosed with respect to this figure are exemplary; the number of states or the definition of such states can vary in different implementations of the disclosed techniques.

Transition tables 510 show that certain combinations of performance states are not permissible (i.e., are prohibited). These restrictions may be due to electrical incompatibilities, and/or certain combinations of performance states not making logical sense. For example, the highest memory interface performance states may not be warranted or necessary in conjunction with the lowest fabric performance states, and vice versa. Stated another way, a low-performance fabric state may not need a high-performance memory state, and a high-performance fabric state may not be satisfied by a low-performance memory state.

As has been described, crossover clock circuit 160 is configured to generate clock signals that cross the boundary between power domains 104A-B. For example, transmit signal 162 (TxD) is used to control writes from the fabric to the memory. In the running example described throughout this disclosure, transmit signal 162 is capable of running at a LO and a HI frequency. The HI frequency in one embodiment may be needed to support full memory bandwidth at certain memory interface performance states (here, F4 or above). But consider a use case for computer system 100 in which it is desired to use the LO frequency for transmit signal 162 while in performance state F4. For example, this combination might be used for operating a camera in a mobile computing platform. This combination would allow a mobile phone to have more power savings for the common use case of camera operation.

With this background, consider transition table 510A. The memory interface has four performance states: F1, F2, F3, and F4’. Performance states F1-F3 are externally defined performance states 132, while performance state F4’ is an internal performance state 134 (meaning that F4’ is not requestable by requestors 106). The fabric has three performance states: V₁, V₂, and V₃, all of which externally defined performance states 132. Accordingly, there are two locations in table 510A (those shaded in the right column labeled F4’) having component performance states that are not part of externally defined states 132.

The frequency of transmit signal 162 is LO for all locations in table 510A. Note that under the externally defined specification of F4, the frequency of transmit signal 162 is HI. The specification of the LO frequency in performance state F4 thus leads to the definition of new internal performance state F4’. In essence, the frequency of transmit signal 162 becomes a third dimension in the combinations of performance states.

Transition table 510A defines one system-level performance state that is not permitted: (F1, V₃, shaded in the first column). Accordingly, if transition table circuit 320A is provided (F1, V₃) as target performance state 132T, transition table circuit 320A will output a transition permission value 148 that indicates that a transition to target performance state 132T is not permitted.

Transition table circuit 320A may be implemented in one embodiment by defining variables that specify the prohibited transitions. This prohibition shown in transition table 510A may be implemented by defining the variable Fabric-HI to be equal to V₃, and the variable Memory-LO to be equal to F1. If numerical equivalents for the four memory interface performance states (e.g., xaxis=1 to 4) and three fabric performance states (yaxis=1 to 3) are defined, the prohibited transition may be identified in transition table circuit 320A using combinatorial logic that checks for the scenario in y-axis = 3 (V₃) and x-axis=1 (F1).

The combination of V₁ and F4’, on the other hand, is permitted in transition table 510A. This constitutes an internal performance state 134 since F4 with the LO frequency for transmit signal 162 is not defined at the PMC interface. But note that entries in transition table 510A in the F4’ column below V₁. These represent permitted states that are transient in nature. Thus, if computer system 100 is operating in low gear (i.e., using transition table circuit 320A) and a transition from V₁to a higher fabric performance state is attempted while in F4’, the hardware will shift to high gear (i.e., begin using transition table circuit 320B). In one embodiment, the light cross-hatched states shown in column F4’ in transition table 510A have reduced memory write bandwidth (due to the lower frequency of transmit signal 162) and may correspond to transient state 410B shown in FIG. 4. Accordingly, transition protection circuit 140 will not prohibit a transition to the cross-hatched states when using transition table circuit 320A, but will instead shift to using transition table circuit 320B.

Next, consider transition table 510B. The memory interface has five performance states: F1 through F5, all of which are externally defined performance states 132. The fabric again has three performance states: V₁, V₂, and V₃, all of which externally defined performance states 132. Accordingly, there are no locations in table 510B having component performance states that are not part of externally defined states 132 (i.e., there are no internally defined performance states in table 510B). The frequency of transmit signal 162 is LO for all locations in table 510B corresponding to columns F1-F3, and is HI for all locations in table 510B corresponding to columns F4-F5.

The high gear of transition table 510B thus allows for the F1 to F5 states and uses the high frequency crossover clock in F4 to F5. But the combination of V₁ and F4-F5 is not permitted in high gear. Hardware will manage the shift between low and high gear. If the hardware is operating in high gear, and shift to F4 or F5 at V₁ is attempted, the hardware will shift to low gear.

FIG. 5B illustrates a single table 510C that shows all possible performance states (both external and internally defined) shown in FIG. 5A. As shown, memory performance states F1-F4’ operate the transmit signal 162 at the LO frequency, while memory performance states F4-F5 operate the transmit signal 162 at the HI frequency. But exposing only memory performance states F1-F5 to software means that the determination of performance states is not unnecessarily complicated. Additionally, a costly hardware redesign is avoided.

FIG. 5C includes diagrams 550 and 570 that further clarify the relationship between target performance state 132T and corresponding internal performance state 134T.

Diagram 550 corresponds to the requestors’ view of the externally defined permissions. Memory interface performance states are shown across axis 560A, while fabric performance states are shown up and down axis 560B. In the illustrated example, performance state processor circuit 130 has selected (F4, V₁) as target performance state 132T.

Diagram 570 shows a three-dimensional, conceptual representation of internal performance states 134. Diagram 570 still includes axes 560A and 560B, but also includes axis 570C, which corresponds to the frequency of transmit signal 162. Target performance state 132T is located at (F4, V₁, LO) within the table in diagram 570, while internal performance state 134T is located at (F4, V₁, HI). Accordingly, one possible conceptual understanding of internal performance states is as a third dimension in what was previously a two-dimensional transition table. (More generally, internal performance states add a dimension to however many dimensions would otherwise exist in a transition table.) Requestors 106 will thus vote for 5 memory performance states, but more than five states are possible using the internal performance states described herein.

Note that in some alternate embodiments, the internal performance states may actually be managed within performance state processor circuit 130, meaning that the equivalent of target performance state 132T could actually be an internal performance state in some cases.

To recap, various embodiments of an apparatus have been described with respect to FIGS. 1-5. One such apparatus, with reference to exemplary reference numerals in this disclosure, includes a computer system (100) implemented on one or more co-packaged integrated circuit dies, which may be constitute, for example, a system-on-a-chip or chiplet architecture. The computer system may include a plurality of agent circuits (170) within a first power domain (104A), one or more memory interface circuits (155) within a second power domain (104B), and a power management circuit (PMC 120). Agent circuits of the plurality of agent circuits are configured to access the one or more memory interface circuits over a boundary between the first power domain and the second power domain. The PMC is configured to determine, based on a set of one or more performance state requests (107) received from one or more requestors (106) within the computer system, a target performance state (132T) for the computer system having component performance states that are specified externally to the PMC as being available to the one or more requestors. The PMC is configured to permit a transition to an internal performance state (134T) for the computer system that is defined internally within the PMC. The internal performance state has at least one component performance state not specified externally to the PMC as being available to be requested by the one or more requestors.

The internal performance state and the target performance state may specify different operating values for a particular circuit within the computer system. For example, the target performance state may be specified as (P1, P2), where P1 and P2 are component performance states for the first and second power domains respectively, and component performance state P2 is associated with a first frequency for a crossover clock signal that crosses the boundary between the first power domain and the second power domain. The internal performance state, on the other hand, is (P1, P2’), where P2’ differs from P2 by being associated with a second, different frequency for the crossover clock signal.

The set of one or more performance state requests may specify one or more of the following parameters: a bandwidth request, a latency request, a real-time request, a particular performance state for the first power domain, a particular performance state for the second power domain. The one or more requestors include one or more of the plurality of agent circuits and one or more software entities, wherein the plurality of agent circuits includes one or more of the following types of agent circuits: processor circuits (170A-B), memory controller circuits, I/O agent circuits (170G-H), graphics processing circuits (170C-D).

In one embodiment, the PMC includes a transition protection circuit (140) configured to provide an indication of the target performance state to each of a plurality of transition table circuits (320) that includes a first transition table circuit that specifies a particular transition permission value. The transition protection circuit is further configured to select, based on a current mode (335) of the transition protection circuit, the particular transition permission value (148) from the first transition table circuit, the particular transition permission value indicating that the transition to the modified target performance state is permitted. In response to an occurrence of a first particular state transition (e.g., 412A), the transition protection circuit is configured to enter a first mode (e.g., state 410C which causes signal 314A to be asserted and selection circuit 330 to store table select signal 335), in which the first of the plurality of transition table circuits is selected for transition checking until occurrence of a second particular state transition (e.g., 412C), at which time the transition protection circuit is configured to enter a second mode (e.g., state 410A which causes signal 314B to be asserted and selection circuit 330 to store table select signal 335) in which a second of the plurality of transition table circuits is selected for transition checking until a subsequent occurrence of the first particular state transition.

In some implementations, to determine the target performance state, the PMC is configured to pin a memory performance state to less than a maximum possible memory performance state available to the computer system. In particular, the PMC may be configured to pin the memory performance state based on a latency tolerance value received from a particular real-time agent circuit. The particular real-time agent circuit may be a peripheral coupled to a bus of the computer system in some embodiments. Such a peripheral is in contrast to a real-time agent that is located on one or more co-packaged ICs making up the core of the computer system—examples of these incorporated devices may include a camera agent circuit, a display agent circuit, an audio agent circuit, etc. In other cases, the real-time agent circuit may be a controller device that uses a buffer to perform memory transactions. In some cases, the particular real-time agent circuit may be a device that is not native to the computer system (e.g., the real-time agent circuit in question was designed by a third-party different from a designer of the components of the computer system that are co-packaged together).

Another disclosed apparatus includes a computer system (100) that includes a first plurality of circuits (e.g., agent circuits 170) within a first power domain (104A), a second plurality of circuits (e.g., memory interface circuits 155) within a second power domain (104B), and a power management circuit (PMC 120). The PMC is configured to receive a set of one or more performance state requests (107) from one or more requestors (106) within the computer system. The PMC is further configured to permit, based on the set of one or more performance state requests, a transition to an internal performance state (134T) defined within the PMC, the internal performance state having at least one component performance state (such as V₁, F4’) that is not one of a plurality of performance states (132) specified externally to the PMC as being available to the one or more requestors. Still further, the PMC is configured to implement transitioning to the internal performance state by causing a change to operation of a particular circuit of the computer system relative to operation of the particular circuit in a particular one of the plurality of performance states. For example, the particular circuit may be a crossover clock circuit (160) having a crossover clock signal (transmit signal 162) that crosses a boundary between the first and second power domains, and wherein the PMC is configured to initiate reducing a frequency of the crossover clock signal (LO frequency in F4’) relative to a frequency at which the crossover clock signal is specified to operate at during the particular one of the plurality of performance states (HI frequency in F4).

The plurality of performance states may include component performance states for the first power domain (V₁, V₂, V₃) and the second power domain (F1-F5). The internal performance state may include a first component performance state for the first power domain (V₁), a second component performance state for the second power domain (F4), and a third component performance state for an operating value of the particular circuit (LO frequency for transmit signal 162). Note that F4’ may also be seen as the combination of F4 and the LO frequency for transmit signal 162 instead of the HI frequency.

The PMC may be further configured to determine, based on the set of one or more performance state requests received from one or more requestors, a target performance state (132T) for the computer system having component performance states within the plurality of performance states (132) specified externally to the PMC as being available to the one or more requestors. The PMC may be still further configured to determine, based on the target performance state, to transition to the internal performance state. To permit the transition to the internal performance state, the PMC may be configured to select one of a plurality of transition table circuits (320) based on a current transition selection mode (335), and determine whether the transition is permitted by presenting the target performance state to the selected transition table circuit.

Note that the reference numerals utilized in this subsection are not intended to be unduly limiting. Instead, these references are intended to be exemplary. Use of “e.g.” before some of these references is not meant to suggest any other references are limiting. For example, the reference to “first particular state transition (e.g., 412A),” might also have been written “first particular state transition (e.g., 412C).”

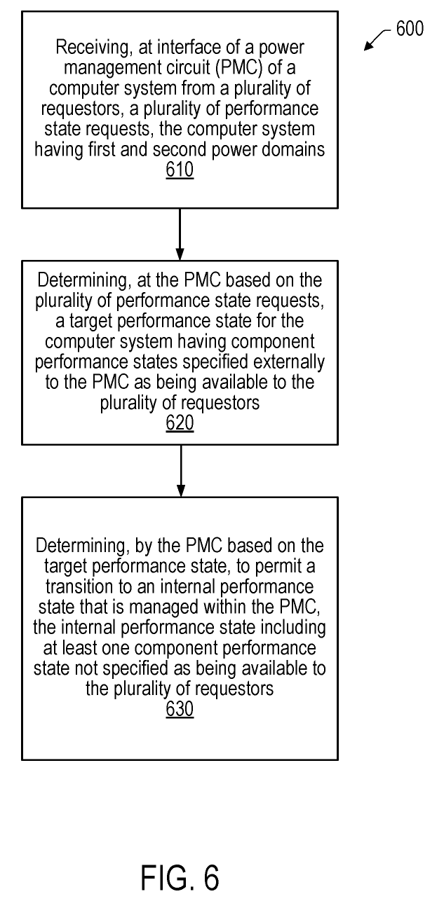

FIG. 6 is a flow diagram of one embodiment of a method 600 for implementing internal performance states within a PMC. Method 600 is thus written from the perspective of a PMC. Exemplary reference numerals to previously described structure and elements is provided for convenience in the following description of method 600. Such reference numerals, however, are not intended to unduly limit the scope of this method.

Method 600 begins in 610, in which the PMC (120) of a computer system (100) receives, at an interface (PMC interface 122) from a plurality of requestors (106), a plurality of performance state requests (107). The computer system includes a first power domain (104A) and a second power domain (104B).

In 620, the PMC determines, based on the plurality of performance state requests, a target performance state (132T) having component performance states (132) specified externally to the PMC as being available to the plurality of requestors. In some embodiments, determining the target performance state includes pinning, based on a real-time maximum performance state setting (234), a memory performance state to less than a maximum possible memory performance state available to the computer system.

In 630, the PMC determines, based on the target performance state (132T), to permit a transition to an internal performance state (134T) that is managed within the PMC, the internal performance state including at least one component performance state not specified as being available to the plurality of requestors (106).

In some implementations, the computer system includes a plurality of agent circuits (170) in the first power domain (104A) and one or more memory interface circuits (155) in the second power domain (104B). A component of the internal performance state (F4’) and a particular one of the plurality of performance states (F4) may differ in a value of a frequency of a crossover clock signal (transmit signal 162) used to transfer data across a boundary between the first power domain and the second power domain.

Versions of the computer system (100) may be usable in a plurality of computing platforms (e.g., mobile computing platform, tablet computing platform, desktop computing platform, wearable computing platform). The internal performance state (134T) may be used for some platforms (e.g., a mobile device computing platform), but not in other ones of the plurality of computing platforms. This may be because certain performance states that are useful in some computing platforms (e.g., filming 4K video on a mobile computing device) are not as useful in other computing platforms (e.g., a desktop system).

In some embodiments, the PMC includes a plurality of transition tables circuits (320) in which a first transition table circuit but not a second transition table circuit includes an entry for the internal performance state (134T). In response to an occurrence of a first particular state transition (e.g., 412A), the PMC is configured to cause the first transition table circuit (320A or 320B) to be used for transition checking until occurrence of a second particular state transition (e.g., 412C), at which time the PMC is configured to cause the second transition table circuit (320B or 320A) to be used for transition checking until a subsequent occurrence of the first particular state transition.

### Example Device

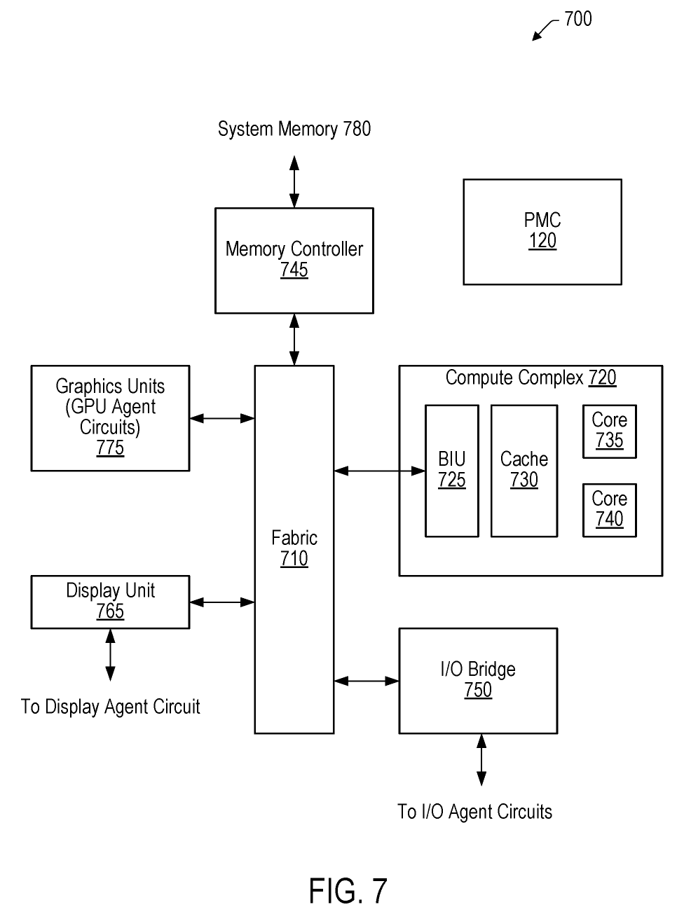

Referring now to FIG. 7, a block diagram illustrating an example embodiment of a device 700 is shown. In some embodiments, elements of device 700 may be included within a system-on-a-chip or distributed on multiple co-packaged integrated circuits as part of a chiplet architecture. In some embodiments, device 700 may be included in a mobile device, which may be battery powered. Therefore, power consumption by device 700 may be an important design consideration. In the illustrated embodiment, device 700 includes fabric 710, compute complex 720 input/output (I/O) bridge 750, memory controller 745, graphics unit 775, display unit 765, system memory 780, and PMC 120. In some embodiments, device 700 may include other components (not shown) in addition to or in place of the illustrated components, such as video processor encoders and decoders, image processing or recognition elements, computer vision elements, etc.

Fabric 710 may include various interconnects, buses, MUX’s, controllers, etc., and may be configured to facilitate communication between various elements of device 700. In some embodiments, portions of fabric 710 may be configured to implement various different communication protocols. In other embodiments, fabric 710 may implement a single communication protocol and elements coupled to fabric 710 may convert from the single communication protocol to other communication protocols internally.

In the illustrated embodiment, compute complex 720 includes bus interface unit (BIU) 725, cache 730, and cores 735 and 740. In various embodiments, compute complex 720 may include various numbers of processors, processor cores and caches. For example, compute complex 720 may include 1, 2, or 4 processor cores, or any other suitable number. In one embodiment, cache 730 is a set associative L2 cache. In some embodiments, cores 735 and 740 may include internal instruction and data caches. In some embodiments, a coherency unit (not shown) in fabric 710, cache 730, or elsewhere in device 700 may be configured to maintain coherency between various caches of device 700. BIU 725 may be configured to manage communication between compute complex 720 and other elements of device 700. Processor cores such as cores 735 and 740 may be configured to execute instructions of a particular instruction set architecture (ISA) which may include operating system instructions and user application instructions. These instructions may be stored in computer readable medium such as a memory coupled to memory controller 745 discussed below.

As used herein, the term “coupled to” may indicate one or more connections between elements, and a coupling may include intervening elements. For example, in FIG. 7, graphics unit 775 may be described as “coupled to” a memory through fabric 710 and memory controller 745. In contrast, in the illustrated embodiment of FIG. 7, graphics unit 775 is “directly coupled” to fabric 710 because there are no intervening elements.

Memory controller 745 may be configured to manage transfer of data between fabric 710 and one or more caches and memories. In various embodiments, memory controller 745 may be coupled to an L3 cache, which may in turn be coupled to a system memory. In other embodiments, memory controller 745 may be directly coupled to a memory. In some embodiments, memory controller 745 may include one or more internal caches. Memory 780 coupled to memory controller 745 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to memory controller 745 may also be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 720 to cause the computing device to perform functionality described herein.

Graphics unit 775 may include one or more processors, e.g., one or more graphics processing units (GPUs). Graphics unit 775 may receive graphics-oriented instructions, such as OPENGL®, Metal®, or DIRECT3D® instructions, for example. Graphics unit 775 may execute specialized GPU instructions or perform other operations based on the received graphics-oriented instructions. Graphics unit 775 may generally be configured to process large blocks of data in parallel and may build images in a frame buffer for output to a di splay, which may be included in the device or may be a separate device. Graphics unit 775 may include transform, lighting, triangle, and rendering engines in one or more graphics processing pipelines. Graphics unit 775 may output pixel information for display images. Graphics unit 775, in various embodiments, may include programmable shader circuitry which may include highly parallel execution cores configured to execute graphics programs, which may include pixel tasks, vertex tasks, and compute tasks (which may or may not be graphics-related).

Display unit 765 may be configured to read data from a frame buffer and provide a stream of pixel values for display. Display unit 765 may be configured as a display pipeline in some embodiments. Additionally, display unit 765 may be configured to blend multiple frames to produce an output frame. Further, display unit 765 may include one or more interfaces (e.g., MIPI® or embedded display port (eDP)) for coupling to a user display (e.g., a touchscreen or an external display).

I/O bridge 750 may include various elements configured to implement: universal serial bus (USB) communications, security, audio, and low-power always-on functionality, for example. I/O bridge 750 may also include interfaces such as pulse-width modulation (PWM), general-purpose input/output (GPIO), serial peripheral interface (SPI), and inter-integrated circuit (I2C), for example. Various types of peripherals and devices may be coupled to device 700 via I/O bridge 750.

In some embodiments, device 700 includes network interface circuitry (not explicitly shown), which may be connected to fabric 710 or I/O bridge 750. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 700 with connectivity to various types of other devices and networks.

As has been described previously, various elements within device 700 may exist in different power domains. For example, one domain may include the various components coupled to fabric 710, as well as a portion of memory controller 745. Another domain may include a portion of memory controller 745 that interfaces to system memory 780. PMC 120, as has been described, is configured to receive performance states from requestors in both power domains.

### Agent Circuits

Agent circuits are circuits that implement functionality for agents within a device such as that shown in FIG. 7. As used herein, an agent is any component or device (e.g., processor, peripheral, memory controller, etc.) that sources and/or sinks communications on one or more of networks (e.g., fabric 710). A source agent circuit generates (sources) a communication, and a destination agent circuit receives (sinks) the communication. A given agent circuit may be a source agent for some communications and a destination agent for other communications.

As used herein, a “processor circuit” refers to any type of central processing unit (CPU). A given processor circuit can include multiple CPUs. For example, one implementation might include a single component with one processing element (i.e., one processor core). Another implementation might include a single component with multiple processor cores (e.g., cores 735 and 740). Yet another implementation might include a processor cluster with multiple components, each of which may include multiple processor cores.

“Memory controllers,” on the other hand refer to any circuit that interfaces to system memory, which includes DRAM. Some embodiments of memory controllers may include memory caches, while others may not. Agent circuits shown in FIG. 7, for example, are able to access memory controller 745 using fabric 710.

In one embodiment, components such as display unit 765 or those coupled to fabric 710 via I/O bridge 750 may be referred to as SoC agents. Some of these SoC agents may also be considered to be input/output (I/O) devices or I/O agents, a broad category that can include an internal or external display, one or more cameras (including associated image signal processor circuits), a Smart IO circuit, and interfaces to various buses such as USB and PCIe. Such circuits can thus be considered to be both SoC agents and I/O agent circuits, where I/O agent circuits are a subset of SoC agents. Other types of SoC agent circuits are possible, including a secure enclave processor, a neural processing engine, JPEG codec circuits, video encoding/decoding circuits, a power manager circuit, an always-on (AON) circuit, etc. Such circuits may thus be SoC agent circuits but not I/O agent circuits.

GPUs such as graphics unit 775 are another type of agent circuit. In some embodiments, GPUs may also be connected to agent circuits acting as memory controllers, allowing GPUs to access system memory via fabric 710.

### Example Applications

Turning now to FIG. 8, various types of systems that may include any of the circuits, devices, or system discussed above. System or device 800, which may incorporate or otherwise utilize one or more of the techniques described herein, may be utilized in a wide range of areas. For example, system or device 800 may be utilized as part of the hardware of systems such as a desktop computer 810, laptop computer 820, tablet computer 830, cellular or mobile phone 840, or television 850 (or set-top box coupled to a television).

Similarly, disclosed elements may be utilized in a wearable device 860, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user’s vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 800 may also be used in various other contexts. For example, system or device 800 may be utilized in the context of a server computer system, such as a dedicated server or on shared hardware that implements a cloud-based service 870. Still further, system or device 800 may be implemented in a wide range of specialized everyday devices, including devices 880 commonly found in the home such as refrigerators, thermostats, security cameras, etc. The interconnection of such devices is often referred to as the “Internet of Things” (IoT). Elements may also be implemented in various modes of transportation. For example, system or device 800 could be employed in the control systems, guidance systems, entertainment systems, etc. of various types of vehicles 890.

The applications illustrated in FIG. 8 are merely exemplary and are not intended to limit the potential future applications of disclosed systems or devices. Other example applications include, without limitation: portable gaming devices, music players, data storage devices, unmanned aerial vehicles, etc.

### Example Computer-readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

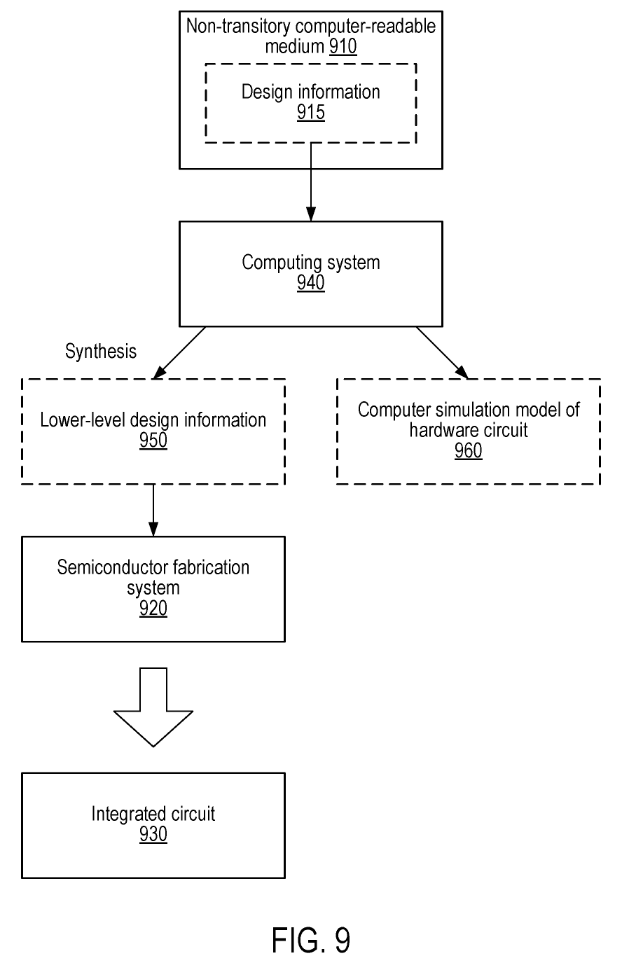

FIG. 9 is a block diagram illustrating an example non-transitory computer-readable storage medium that stores circuit design information, according to some embodiments. In the illustrated embodiment, computing system 940 is configured to process the design information. This may include executing instructions included in the design information, interpreting instructions included in the design information, compiling, transforming, or otherwise updating the design information, etc. Therefore, the design information controls computing system 940 (e.g., by programming computing system 940) to perform various operations discussed below, in some embodiments.

In the illustrated example, computing system 940 processes the design information to generate both a computer simulation model 960 of a hardware circuit and lower-level design information 950. In other embodiments, computing system 940 may generate only one of these outputs, may generate other outputs based on the design information, or both. Regarding the computing simulation, computing system 940 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 940 also processes the design information to generate lower-level design information 950 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 950 (potentially among other inputs), semiconductor fabrication system 920 is configured to fabricate an integrated circuit 930 (which may correspond to functionality of the simulation model 960). Note that computing system 940 may generate different simulation models based on design information at various levels of description, including information 950, 915, and so on. The data representing design information 950 and model 960 may be stored on medium 910 or on one or more other media.

In some embodiments, the lower-level design information 950 controls (e.g., programs) the semiconductor fabrication system 920 to fabricate the integrated circuit 930. Thus, when processed by the fabrication system, the design information may program the fabrication system to fabricate a circuit that includes various circuitry disclosed herein.

Non-transitory computer-readable storage medium 910, may comprise any of various appropriate types of memory devices or storage devices. Non-transitory computer-readable storage medium 910 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 910 may include other types of non-transitory memory as well or combinations thereof. Accordingly, non-transitory computer-readable storage medium 910 may include two or more memory media; such media may reside in different locations—for example, in different computer systems that are connected over a network.

Design information 915 may be specified using any of various appropriate computer languages, including hardware description languages such as, without limitation: VHDL, Verilog, SystemC, SystemVerilog, RHDL, M, MyHDL, etc. The format of various design information may be recognized by one or more applications executed by computing system 940, semiconductor fabrication system 920, or both. In some embodiments, design information may also include one or more cell libraries that specify the synthesis, layout, or both of integrated circuit 930. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 930 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 920 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 920 may also be configured to perform various testing of fabricated circuits for correct operation.

In various embodiments, integrated circuit 930 and model 960 are configured to operate according to a circuit design specified by design information 915, which may include performing any of the functionality described herein. For example, integrated circuit 930 may include any of various elements shown in FIGS. 1-5. Further, integrated circuit 930 may be configured to perform various functions described herein in conjunction with other components. Further, the functionality described herein may be performed by multiple connected integrated circuits.

As used herein, a phrase of the form “design information that specifies a design of a circuit configured to …” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 920 to fabricate integrated circuit 930.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of … w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of … w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” (performing a function) construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom-designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. An apparatus, comprising:
a computer system implemented on one or more co-packaged integrated circuit dies, the computer system including:
a plurality of agent circuits within a first power domain;
one or more memory interface circuits within a second power domain, wherein agent circuits of the plurality of agent circuits are configured to access the one or more memory interface circuits over a boundary between the first power domain and the second power domain; and
a power management circuit (PMC) configured to:
determine, based on a set of one or more performance state requests received from one or more requestors within the computer system, a target performance state for the computer system having component performance states that are specified externally to the PMC as being available to the one or more requestors; and
permit a transition to an internal performance state for the computer system that is defined internally within the PMC, wherein the internal performance state has at least one component performance state not specified externally to the PMC as being available to be requested by the one or more requestors.

2. The apparatus of claim 1, wherein the internal performance state and the target performance state specify different operating values for a particular circuit within the computer system.

3. The apparatus of claim 2, wherein the target performance state is (P1, P2), wherein P1 and P2 are component performance states for the first and second power domains respectively, wherein component performance state P2 is also associated with a first frequency for a crossover clock signal that crosses the boundary between the first power domain and the second power domain; and
wherein the internal performance state is (P1, P2’), wherein P2’ differs from P2 by being associated with a second, different frequency for the crossover clock signal.

4. The apparatus of claim 1, wherein the set of one or more performance state requests specify one or more of the following parameters: a bandwidth request, a latency request, a real-time request, a particular performance state for the first power domain, a particular performance state for the second power domain.

5. The apparatus of claim 1, wherein the one or more requestors include one or more of the plurality of agent circuits and one or more software entities, wherein the plurality of agent circuits includes one or more of the following types of agent circuits: processor circuits, memory controller circuits, I/O agent circuits, graphics processing circuits.

6. The apparatus of claim 1, wherein the PMC includes a transition protection circuit configured to:
provide an indication of the target performance state to each of a plurality of transition table circuits that includes a first transition table circuit that specifies a particular transition permission value; and
select, based on a current mode of the transition protection circuit, the particular transition permission value from the first transition table circuit, the particular transition permission value indicating that the transition to the internal performance state is permitted.

7. The apparatus of claim 6, wherein, in response to an occurrence of a first particular state transition, the transition protection circuit is configured to enter a first mode in which the first of the plurality of transition table circuits is selected for transition checking until occurrence of a second particular state transition, at which time the transition protection circuit is configured to enter a second mode in which a second of the plurality of transition table circuits is selected for transition checking until a subsequent occurrence of the first particular state transition.

8. The apparatus of claim 1, wherein, to determine the target performance state, the PMC is configured to pin a memory performance state to less than a maximum possible memory performance state available to the computer system.

9. The apparatus of claim 8, wherein the PMC is configured to pin the memory performance state based on a latency tolerance value received from a particular real-time agent circuit.

10. The apparatus of claim 9, wherein the particular real-time agent circuit is a peripheral coupled to a bus of the computer system.

11. A method, comprising:
receiving, at an interface of a power management circuit (PMC) of a computer system from a plurality of requestors, a plurality of performance state requests, the computer system having a first power domain and a second power domain;
determining, at the PMC based on the plurality of performance state requests, a target performance state for the computer system having component performance states specified externally to the PMC as being available to the plurality of requestors; and
determining, by the PMC based on the target performance state, to permit a transition to an internal performance state that is managed within the PMC, the internal performance state including at least one component performance state not specified as being available to the plurality of requestors.

12. The method of claim 11, wherein the computer system includes a plurality of agent circuits in the first power domain and one or more memory interface circuits in the second power domain, and wherein a component performance state of the internal performance state and a component performance state of the target performance differ in a value of a frequency of a crossover clock signal used to transfer data across a boundary between the first power domain and the second power domain.

13. The method of claim 12, wherein versions of the computer system are usable in a plurality of computing platforms, wherein the internal performance state is for use of the computer system in a mobile device computing platform, but not in one or more other ones of the plurality of computing platforms.

14. The method of claim 11, wherein the PMC includes a plurality of transition tables circuits in which a first transition table circuit but not a second transition table circuit includes an entry for the internal performance state; and
wherein, in response to an occurrence of a first particular state transition, the PMC is configured to cause the first transition table circuit to be used for transition checking until occurrence of a second particular state transition, at which time the PMC is configured to cause the second transition table circuit to be used for transition checking until a subsequent occurrence of the first particular state transition.

15. The method of claim 11, wherein determining the target performance state includes pinning, based on a real-time agent maximum performance state setting, a memory performance state to less than a maximum possible memory performance state available to the computer system.

16. An apparatus, comprising:
a computer system that includes:
a first plurality of circuits within a first power domain;
a second plurality of circuits within a second power domain; and
a power management circuit (PMC) configured to:
receive a set of one or more performance state requests from one or more requestors within the computer system;
permit, based on the set of one or more performance state requests, a transition to an internal performance state defined within the PMC, the internal performance state having at least one component performance state that is not one of a plurality of performance states specified externally to the PMC as being available to the one or more requestors; and
implement transitioning to the internal performance state by causing a change to operation of a particular circuit of the computer system relative to operation of the particular circuit in a particular one of the plurality of performance states.

17. The apparatus of claim 16, wherein the particular circuit is a crossover clock circuit having a crossover clock signal that crosses a boundary between the first and second power domains, and wherein the PMC is configured to initiate reducing a frequency of the crossover clock signal relative to a frequency at which the crossover clock signal is specified to operate at during the particular one of the plurality of performance states.

18. The apparatus of claim 16, wherein the plurality of performance states includes component performance states for the first power domain and the second power domain, and wherein the internal performance state includes a first component performance state for the first power domain, a second component performance state for the second power domain, and a third component performance state for an operating value of the particular circuit.

19. The apparatus of claim 16, wherein the PMC is configured to:
determine, based on the set of one or more performance state requests received from one or more requestors, a target performance state for the computer system having component performance states within the plurality of performance states specified externally to the PMC as being available to the one or more requestors; and
determine, based on the target performance state, to transition to the internal performance state.

20. The apparatus of claim 19, wherein, to permit the transition, the PMC is configured to select one of a plurality of transition table circuits based on a current transition selection mode, and determine whether the transition is permitted by presenting the target performance state to the selected transition table circuit.
